(19) United States
(12) Patent Application Publication
(10) Pub. No.: US 2010/0187836 A1
(43) Pub. Date: Jul. 29, 2010

(54) LATCH

(76) Inventor: David Mark Mason, Nottingham (GB)

Correspondence Address: Clise, Billion & Cyr, P.A., 605 U.S. Highway 169, Suite 300, Plymouth, MN, 55441, US

(21) Appl. No.: 12/664,552

(22) PCT Filed: Jun. 16, 2008
(86) PCT No.: PCT/GB2008/002038

§ 371 Date: Dec. 14, 2009

(30) Foreign Application Priority Data
Jun. 16, 2007 (GB) 0711678.3

(51) Int. Cl. E05C 19/12; A44B 18/00; A44B 99/00; B23P 17/00

(52) U.S. Cl. 292/95; 29/527.1

(57) ABSTRACT

A latch for releasably sealing a box, the latch comprising a first part and a second part arranged to be attached to respective opposing flaps of a box lid, the first and second parts comprising respective first and second attachment elements arranged to releasably engage one another thereby to seal the box, wherein the latch is elongate and the attachment elements have a substantially uniform cross-section along their length.

The invention relates to a latch for releasably sealing a box, a box including the latch and a method of manufacturing the latch. The invention also relates to a latch for releasably securing two surfaces together.

### BACKGROUND

Boxes, particularly cardboard boxes, are regularly used for storage of household items. These are often kept in attics, garages and sheds. Many items are delicate and as a result the boxes may be sealed using tape to secure the lids to and protect the contents from dust, but this is often inconvenient, particularly when the items are needed (Christmas decorations for instance).

In addition, cardboard boxes are often used to store personal and private documents or possessions. It is often desirable to seal these boxes to avoid prying eyes (when moving home for instance or in a spare room). Once again, tape can be used, but this is inconvenient, particularly for semi-permanent storage situations.

The listing or discussion of a prior-published document in this specification should not necessarily be taken as an acknowledgement that the document is part of the state of the art or is common general knowledge.

### SUMMARY

According to a first aspect, there is provided a latch for releasably securing two surfaces together, the latch comprising
a first part and a second part arranged to be attached to respective opposing surfaces, the first and second parts comprising respective first and second attachment elements arranged to releasably engage one another thereby to secure the surfaces together, wherein the attachment elements are elongate with a substantially uniform cross-section along their length.

By having a substantially uniform cross-section, the latch is able to be produced by extrusion, for example, and cut to a desired length by the manufacturer, a retailer, distributor or the end user. The latch may be sold in rolls or in long strips, for example. Any part of the roll or strip may be cut off and used as a latch. The user is thus able to fit the latch appropriately to the dimensions of a particular box to be sealed.

By “substantially uniform” it is meant that there is no significant variation in the cross-section. Non-significant variations may include variations which locally alter the cross-section of the latch but which occur only occasionally along its length (for example holes, notches or grooves), or variations which modify the cross-section along the length of the latch but which do not significantly alter the cross-section, for example surface decoration on the latch.

Latches of the present invention may include those commonly referred to as “over-centre toggle latches”.

According to this aspect, there is also provided a latch for releasably sealing a box, the latch comprising
a first part and a second part arranged to be attached to respective opposing flaps of a box lid, the first and second parts comprising respective first and second attachment elements arranged to releasably engage one another thereby to seal the box, wherein the attachment elements are elongate with a substantially uniform cross-section along their length.

The latch of the present invention is applicable, not only to the sealing of boxes, but also the securing of two surfaces, in a wide variety of situations, described in detail elsewhere herein.

According to a second aspect, there is provided a latch for releasably securing two surfaces together, the latch comprising
a first part and a second part arranged to be attached to respective opposing surfaces, the first and second parts comprising respective first and second attachment elements arranged to releasably engage one another along their length thereby to secure the surfaces together. According to the second aspect, there is also provided a latch for releasably sealing a box, the latch comprising
a first part and a second part arranged to be attached to respective opposing flaps of a box lid, the first and second parts comprising respective first and second attachment elements arranged to releasably engage one another along their length thereby to seal the box.

With the attachment elements engaging along their length, the latch provides the ability to seal the box along the length of the flaps of the box lid, securing the box to prevent the ingress of dust etc.

In either or both of these ways, the latch according to the invention serves as a secure, reusable alternative to parcel tape. The latch eliminates the need for a separate latch and seal. The latch itself creates the seal along its full length. Preferably the full length of the latch comprises substantially all advantageously the full length of the flaps.

The first attachment element may comprise a keeper and the second attachment element comprises a hooked part, wherein the hooked part is connected to a base of the second part by a hinge mechanism, the hinge mechanism being arranged to allow the hooked part to be positioned over the keeper and to be moved into a latched position in which the hooked part engages the keeper to secure the first and second parts together.

The hinge mechanism may be arranged to maintain the engagement between the hooked part and the keeper in the latched position.

The hinge mechanism may comprise an intermediate part connecting the hooked part to the base of the second part, the intermediate part comprising a first hinge element connecting the hooked part to the intermediate part and a second hinge element connecting the intermediate part to the base.

In the latched position, the intermediate part may be arranged to be under compression in such a way that, via its connection with the hooked part and the base, it urges the hooked part against the keeper in order to secure the hooked part in the latched position.

Each hinge element may comprise a region of material which is of reduced rigidity compared to surrounding regions.

Each of the first and second attachment elements may comprise velcro and/or a magnetic part.

The first part may comprise a hinged part attached to a base of the first part, the hinged part comprising the first attachment element and being movable so as to bring the first attachment element into a latched position in which it engages the second attachment element.

One or both of the first and second parts may comprise a securing clip for attachment to an edge of the respective box lid flap.

One or both of the first and second parts may comprise an adhesive pad for attachment to the respective box lid flap.

The latch may comprise a locking mechanism arranged to lock the first and second attachment elements together.

The locking mechanism may comprise a locking pillar arranged to be inserted through an aperture in one or both of the first and second attachment elements.

An upper part of the locking pillar may comprise an aperture through which a padlock or the like can be inserted.

The locking pillar may be rotatably mounted within the aperture in the first and/or second attachment element. The upper part may have a non-circular cross-section, the aperture in the first and/or second attachment element comprising a corresponding non-circular cross-section, the upper part being rotatable between a locked position in which its cross-section prevents its passage through the aperture and an unlocked position in which it may pass through the aperture. In a variant, the locking pillar may be fixedly attached to the first and/or second attachment element, with the upper part being rotatably attached to the locking pillar.

Each of the first and second parts may consist of an extruded length of material.

The latch may be arranged to be cut to a desired length.

According to a third aspect, there is provided a box including the latch of the first and/or second aspect.

According to a fourth aspect, there is provided a method of manufacturing a latch for releasably securing two surfaces together, the method comprising
producing first and second parts of the latch, the first and second parts being arranged to be attached to respective opposing surfaces, the first and second parts comprising respective first and second attachment elements arranged to releasably engage one another thereby to secure the surfaces together, wherein the latch is elongate and the first and second parts have a substantially uniform cross-section along their length.

According to this aspect, there is also provided a method of manufacturing a latch for releasably sealing a box, the method comprising
producing first and second parts of the latch, the first and second parts being arranged to be attached to respective opposing flaps of a box lid, the first and second parts comprising respective first and second attachment elements arranged to releasably engage one another thereby to seal the box, wherein the latch is elongate and the attachment elements have a substantially uniform cross-section along their length.

The method may comprise producing the first and second parts using a continuous profile mass-production technique.

The method may comprise producing the first and second parts using extrusion.

The method may comprise producing the first and second parts using injection moulding.

The method may comprise cutting one or both of the first and second parts to a desired length.

According to a fifth aspect, there is provided a method of manufacturing a latch for releasably securing two surfaces together, the method comprising
cutting first and second parts of the latch to a desired length, the first and second parts being arranged to be attached to respective opposing surfaces, the first and second parts comprising respective first and second attachment elements arranged to releasably engage one another thereby to secure the surfaces together, wherein the latch is elongate and the first and second parts have a substantially uniform cross-section along their length.

According to this aspect, there is also provided a method of manufacturing a latch for releasably sealing a box, the method comprising
cutting first and second parts of the latch to a desired length, the first and second parts being arranged to be attached to respective opposing flaps of a box lid, the first and second parts comprising respective first and second attachment elements arranged to releasably engage one another thereby to seal the box, wherein the latch is elongate and the attachment elements have a substantially uniform cross-section along their length.

According to a sixth aspect, there is provided a latch for releasably sealing a box, the latch comprising
a first part and a second part arranged to be attached to respective opposing flaps of a box lid, the first and second parts comprising respective first and second attachment elements arranged to releasably engage one another thereby to seal the box along the flaps, wherein each of the attachment elements comprises an extruded piece of material.

The latch may be arranged to be cut to a desired length.

Advantages that may result from the present invention may be as follows:
The latch has the ability to seal a box along its full length: The seal is achieved by the close fit of the hook and keeper, and the fact that this close fit is maintained by the latching mechanism i.e. the intermediate part being held in compression. The seal is also improved by preventing the ingress of dirt whilst opening. In addition, the adhesive pad and securing clips seal the joint between latch and box. The seal may be achieved by the magnetic strip or Velcro.
The full length is achieved by cutting to the length of the box, i.e. customisable. The uniform cross section allows it to be cut anywhere along its length.
The latch may be releasable (incorporating re-closeable): the present invention may allow the box to be opened and closed as many times as required without damage to the box or the latch. Previously, a user would seal the box with tape (which is not re-usable and tends to damage the box) or by interlacing the flaps (half over and half under the neighbouring flaps) which also damages the box. This releasable feature means that the box is reusable.
The latch may be lockable: The present invention may allow sensitive or private times to be stored without the possibility of inquisitive visitors/guests/staff taking a peek at the contents. The locking pillar and aperture can provide this advantage by allowing the use of a padlock or other simple locking mechanism e.g. cable tie. While a cardboard box could be ripped open, for most privacy situations the latch and padlock would be sufficient.
The latch allows ease of manufacture: The device can be made by extrusion from two homogeneous pieces of plastic. The design is such that the hinges/compression mechanism and seal are all incorporated without further manufacture or additional materials. This minimises price which is important because it is used on a cardboard box which is seen by most home users as being inexpensive or even free (e.g. a packaging by-product of something they have brought).

According to another form of the present invention, there is provided an over-centre toggle latch for releasably securing two surfaces, the toggle latch comprising a first part and a second part arranged to be attached to said respective surfaces, the first part having a compression bar and latching arm for securing the surfaces together, the bar and arm being elongate with a substantially uniform cross-section along their lengths.

According to this form, there is also provided an over-centre toggle latch for releasably securing two surfaces, the toggle latch comprising a first part and a second part arranged to be attached to respective surfaces, the first part having a compression bar and latching arm for securing the surfaces together, the bar and arm being arranged to releasably engage one another along their length thereby to secure the two surfaces.

The present invention is applicable not only to boxes and containers as discussed in the specific description, but also more widely to other applications involving securing of surfaces to be generally co-planar.

Applications for the toggle latch include:
In medical applications where high value products are delivered in a multitude of differing packages. Plastic boxes/crates/drums benefit from the extruded latch mechanism. The latch toggle is low-cost to make and is easy to sterilise due to the homogenous design. Tamper-evident mechanisms may be incorporated.
In the electronics/computer/High Voltage switchgear industries, to hold circuit boards, electrical elements and panels in position. The material is typically plastic (probably PVC) which is a good electrical insulator thus avoiding problems with air gap and electrical shorts associated with metal fixings.
In the construction and civil engineering industries to hold panels or shuttering. Suspended ceiling tiles and air conditioning ducting access hatches benefit such that the extruded latch grips along the full length of the latch. Sealing strips can be incorporated to improve it's sealing capabilities.
In aerospace and car industries, benefiting from a light-weight, rattle-resistant latch mechanism to locate many removable items. Engineering plastics may be used to reduce weight and improve strength and performance.
At sea, on ships and oil platforms to locate removable items. The corrosion resistance of plastic is superior to many metals.

The present invention includes one or more aspects, embodiments or features in isolation or in various combinations whether or not specifically stated (including claimed) in that combination or in isolation.

The above summary is intended to be merely exemplary and non-limiting.

### BRIEF DESCRIPTION OF THE DRAWINGS

A description is now given, by way of example only, with reference to the accompanying drawings, in which:—

FIG. 1 shows a box sealed using a latch according to the invention;

FIG. 2 is a perspective view of a first embodiment of a latch according to the invention;

FIG. 3 is a cross-section of the latch of FIG. 2;

FIG. 4 is another perspective view of the latch of FIG. 2;

FIG. 5 is a perspective view of a second embodiment of a latch according to the invention;

FIG. 6 is a cross-section of the latch of FIG. 5;

FIG. 7 is another perspective view of the latch of FIG. 5;

FIG. 8 shows part of a locking mechanism according to the invention;

FIG. 9 is a flowchart representing a method according to the invention;

FIG. 10 is a flowchart representing another method according to the invention;

FIGS. 11 to 13 illustrate another embodiment of a latch; and

FIGS. 14 and 15 show a further embodiment of the latch

### DETAILED DESCRIPTION

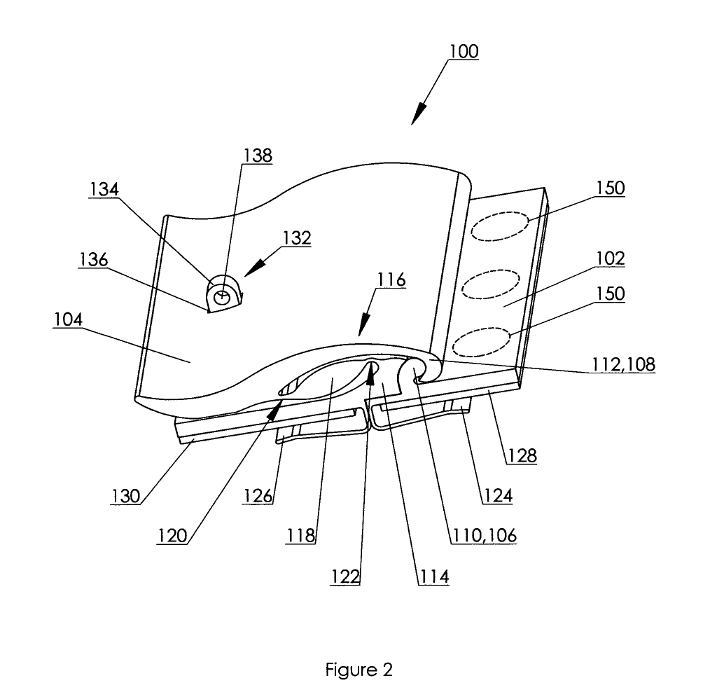

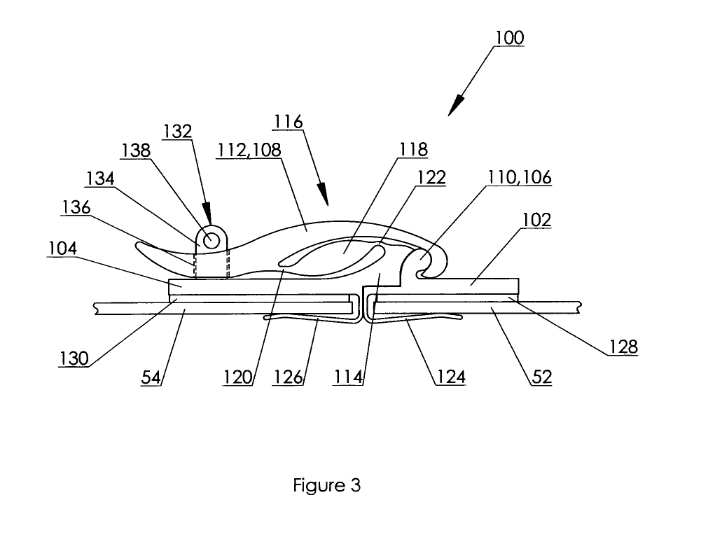

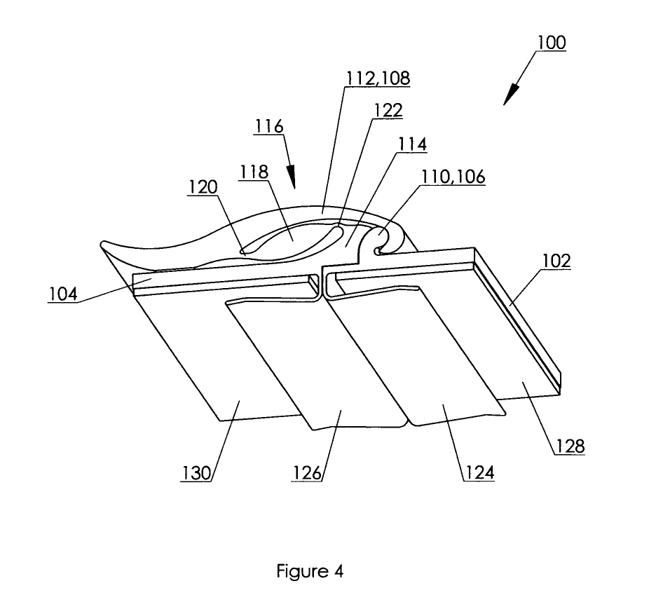

FIGS. 2 to 4 show a latch 100 being a first embodiment of the invention.

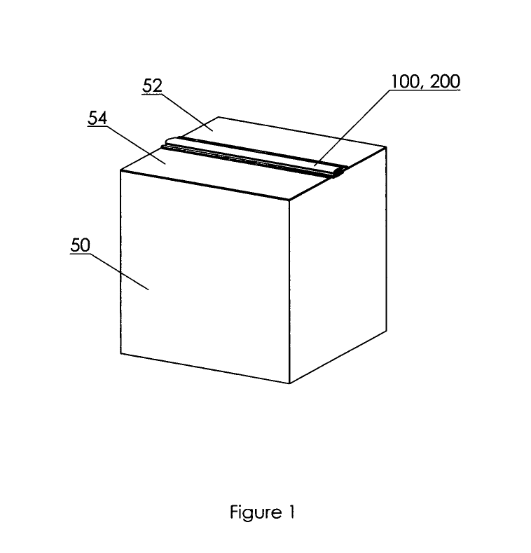

The latch 100 is designed for releasably sealing a box 50 (see FIG. 1) and comprises a first part 102 and a second part 104 arranged to be attached to respective opposing flaps 52, 54 of the box lid. Each of the first and second parts 102, 104 consists of an extruded length of material. The first and second parts 102, 104 comprise respective first and second attachment elements 106, 108 arranged to releasably engage one another thereby to seal the box 50. The attachment elements are elongate and have a substantially uniform cross-section along their length. The first and second attachment elements 106, 108 are arranged to releasably engage along their length.

The first attachment element 106 comprises a keeper 110 and the second attachment element 108 comprises a hooked part 112. The hooked part 112 is connected to a base 114 of the second part 104 by a hinge mechanism 116. The hinge mechanism 116 is arranged to allow the hooked part 112 to be positioned over the keeper 110 and to be moved into a latched position in which the hooked part 112 engages the keeper 110 to secure the first and second parts 102, 104 together. The hinge mechanism 116 is arranged to maintain the engagement between the hooked part 112 and the keeper 110 in the latched position.

The hinge mechanism 116 comprises an intermediate part 118 connecting the hooked part 112 to the base 114 of the second part 104. The hinge mechanism 116 comprises a first hinge element 120 connecting the hooked part 112 to the intermediate part 118 and a second hinge element 122 connecting the intermediate part 118 to the base 114. Each hinge element 120, 122 consists of a region of material which is thinner, and therefore of reduced rigidity, compared to surrounding regions. In a variant, the hinge elements 120, 122 comprise regions of material which are weaker, and therefore of reduced rigidity, compared to surrounding regions.

In the latched position, the intermediate part 118 is arranged to be under compression in such a way that, via its connection with the hooked part 112 and the base 114, it urges the hooked part 112 against the keeper 110 in order to secure the hooked part 112 in the latched position.

The intermediate part 118 is under maximum compression at a point partway between the latched position and an unlatched position. In this way, when the hooked part 112 is being moved from the unlatched position to the latched position, it snaps into the latched position after it passes the point of maximum compression.

The first part 102 comprises a first securing clip 124 for attachment to an edge of the first box lid flap 52 and the second part 104 comprises a second securing clip 126 for attachment to an edge of the second box lid flap 54.

The first part 102 comprises a first adhesive pad 128 for attachment to the first box lid flap 52 and the second part 104 comprises a second adhesive pad 130 for attachment to the second box lid flap 54.

The latch 100 comprises a locking mechanism 132 arranged to lock the first and second attachment elements 106, 108 together. The locking mechanism 132 comprises a locking pillar 134 arranged to be inserted through an aperture 136 in the second attachment element 108. An upper part of the locking pillar 134 comprises an aperture 138 through which a padlock (not shown) or the like can be inserted.

The first part 102, for example at the base parts adjacent the adhesive pads, may have a number of apertures 150 (shown in broken lines) spaced along its length for weight-saving and/or minimisation of material used, where appropriate. The apertures may be produced (e.g. by punching) after the forming of the first part, or they may be created as an integral element of the formation of the first part e.g. in an injection moulding operation.

In a variant, for example the first part is made by injection-moulding, and incorporates strengthening ribs and pockets arranged longitudinally and/or cross-wise.

In use, a user obtains a length of latch 100 (consisting of the first and second parts 102, 104) and the box 50 to be sealed. The user cuts the latch 100 to such a length that the latch 100 will extend along the length of the flaps of the box lid. In a variant, a manufacturer cuts the latch 100 to length and the latch is sold to fit boxes 50 of standard size.

In order to seal the box 50, the user attaches the first part 102 to the first box lid flap 52 and the second part 104 to the second box lid flap 54 using the securing clips 124, 126 and adhesive pads 128, 130. In order to lock the latch 100, the user operates the hooked part 112 so as to move it over and behind the keeper 110, and then moves the hooked part 112 downwardly into its latched position.

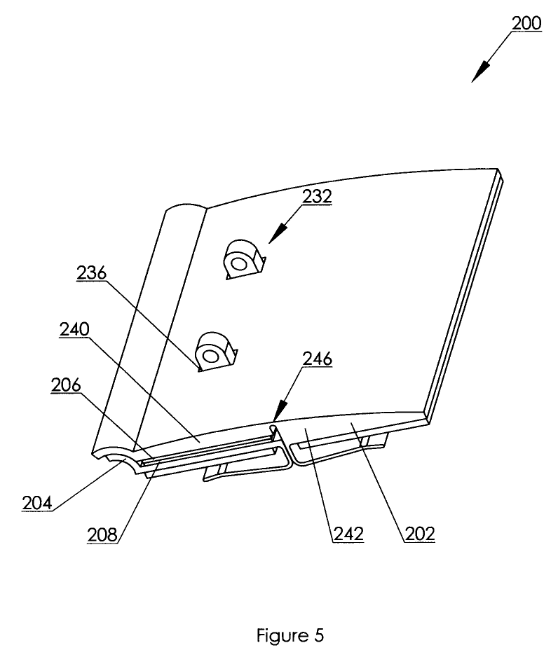

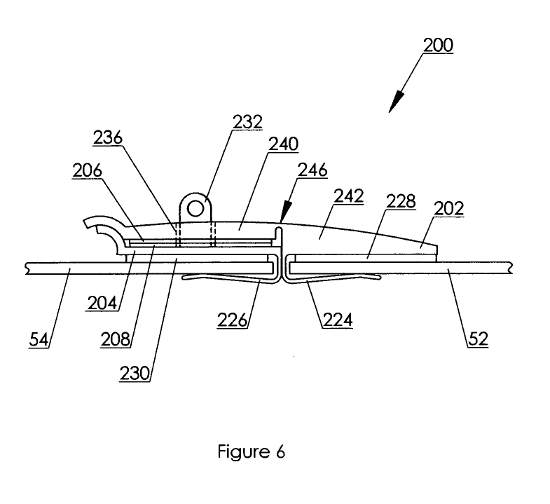

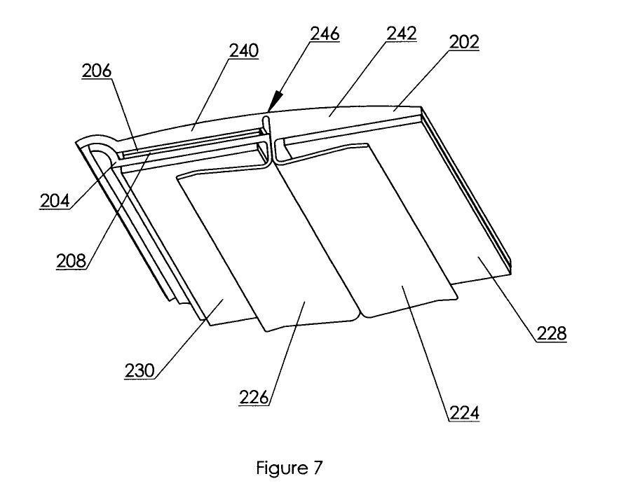

FIGS. 5 to 7 show a latch 200 being a second embodiment of the invention.

Like the latch 100 of the first embodiment, the latch 200 is designed for releasably sealing a box 50 and comprises a first part 202 and a second part 204 arranged to be attached to respective opposing flaps 52, 54 of the box lid. Each of the first and second parts 202, 204 consists of an extruded length of material. The first and second parts 202, 204 comprise respective first and second attachment elements 206, 208 arranged to releasably engage one another thereby to seal the box 50. The attachment elements are elongate and have a substantially uniform cross-section along their length. The first and second attachment elements 206, 208 are arranged to releasably engage along their length.

The first part 202 comprises a hinged part 240 attached to its base 242. The hinged part 240 is attached to the base 242 by a hinge 246. The hinged part 240 comprises the first attachment element 206 and is movable so as to bring the first attachment element 206 into a latched position in which it engages the second attachment element 208, and into an unlatched position in which it is disengaged from the second attachment element 208. Each of the first and second attachment elements 206, 208 comprises a magnetic part, whereby the two attachment elements 206, 208 engage one another. In a variant, each of the first and second attachment elements 206, 208 comprises velcro.

All other features of the latch 200 shown in FIGS. 5 to 7 correspond to those of the latch 100 shown in FIGS. 2 to 4.

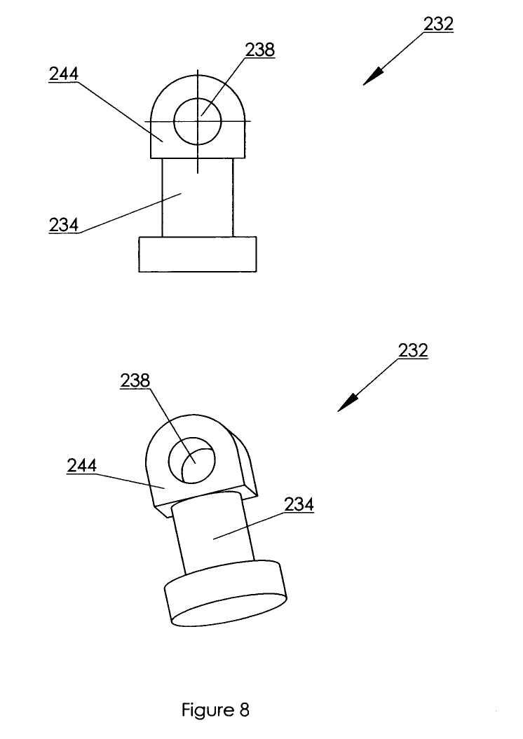

FIG. 8 shows part of a locking mechanism 232 of the latch 200.

The locking mechanism 232 comprises a locking pillar 234 arranged to be inserted through an aperture 236 in the second part 204, the first and second attachment elements 206, 208 and the hinged part 240. An upper part 244 of the locking pillar 234 comprises an aperture 238 through which a padlock (not shown) or the like can be inserted. The locking pillar 234 is rotatably mounted with the aperture 236 and the upper part 244 has a non-circular cross-section. The aperture 236 comprises a corresponding non-circular cross-section. The upper part 244 is rotatable between a locked position in which its cross-section prevents its passage through the aperture 236 and an unlocked position in which it may pass through the aperture 236. In a variant, the locking mechanism 232 replaces the locking mechanism 132 of the latch 100.

FIG. 1 shows a box 50 sealed using a latch 100, 200 according to the invention

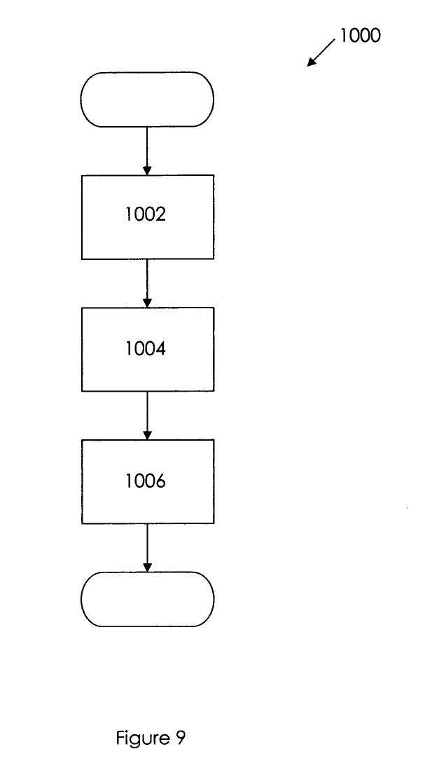

FIG. 9 is a flowchart representing a method 1000 of manufacturing a latch (according to either of the first and second embodiments) for releasably sealing a box.

The method 1000 comprises the step 1002 of producing first and second parts of the latch, the first and second parts being arranged to be attached to respective opposing flaps of a box lid, the first and second parts comprising respective first and second attachment elements arranged to releasably engage one another thereby to seal the box, wherein the latch is elongate and the first and second parts have a substantially uniform cross-section along their length. The method 1000 optionally includes the step 1004 of punching a plurality of apertures 150 in the first parts 102. Then there is the step 1006 of cutting one or both of the first and second parts to a desired length.

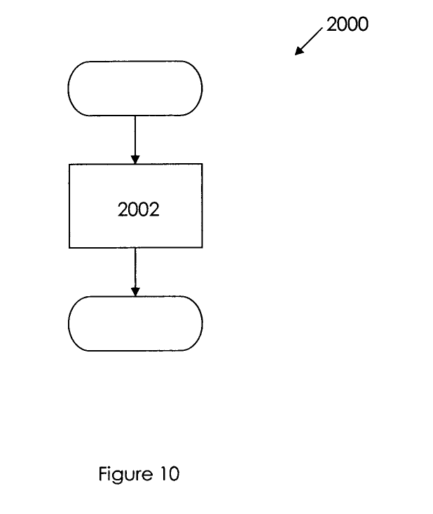

FIG. 10 is a flowchart representing a method 2000 of manufacturing a latch for releasably sealing a box. The method 2000 comprises the step 2002 of cutting first and second parts of the latch to a desired length, the first and second parts being arranged to be attached to respective opposing flaps of a box lid, the first and second parts comprising respective first and second attachment elements arranged to releasably engage one another thereby to seal the box, wherein the latch is elongate and the first and second parts have a substantially uniform cross-section along their length.

A variant to described latches may include latch mechanisms (of say 2 cm width) spaced equally along a seal/base. A strip of the seal/base can be cut to provide a certain number of latches along the strip. In this way, the seal may be tighter near to the latches. A higher count of individual latches improves the sealing property but leads to increased inconvenience when sealing or opening a box. A lower count is more convenient but less likely to make a good seal.

The over-centre toggle latch is a well known device often used on industrial cases and equipment to securely hold a lid or panel in a closed position. The device usually consists of a keeper/anchor part that is connected to one lid or panel and a second latch part that is connected to the case body or a second panel.

The latch part (not including the keeper) typically has three items. These are as follows:

1) A base component that is secured to the case body.
2) A latching arm that can be hooked over the anchor point on the keeper.
3) An intermediate compression bar that connects the base part to the latching arm.

The three parts are arranged such that the base is connected via a hinge to the compression bar which in turn is connected by hinge to the latching arm. Due to the two hinges at the points where the components meet, the compression bar can rotate around one axis and the latching arm can rotate about two. This results in the latching arm being able to move both horizontally and vertically with respect to the base, and provides the latching arm with a degree of reach. This flexibility in movement means that the hook at the end of the latching arm can easily be located over the keeper even if the keeper is slightly misaligned with respect to the latch base.

Once the latching arm hook has been placed over the anchor point on the keeper, compression of the latching arm towards the base results in the keeper being pulled towards the latch base, i.e. the case is pulled towards the closed to position.

At a certain point during the closure, the compression bar is under maximum force. This occurs when the two hinges and the anchor point on the keeper are in alignment. When the latch moves beyond this point, compression is slightly released. Eventually, as the latch is pushed further, it reaches the end of its movement, which is usually when the latch touches the body of the case. The latch tends naturally to stay in this position, because to open would mean that the compression bar would need to move from its current relatively unstressed state back past the point of maximum compression, i.e. energy would need to be put in to open the latch. If no energy is put in, the latch tends to stay in the closed position.

The device is opened by pulling the latching arm towards, through and then past the point of maximum compression.

Most toggle latches of this type are usually made from metal. They are made in a variety of shapes and sizes ranging from small latches on a plastic tool box, to large cast toggle latches designed to hold heavy panels in position.

This further aspect of the invention may provide toggle latches by extrusion. An advantage over conventional methods is that the latch can be extruded in long lengths and then cut to size for the end user. The lengths can be cut to produce latches equivalent in size to the existing metal latches or alternatively they could be used in long lengths to seal the full height of a door for example.

The latch part can be made by a single extrusion process whereby the flexible hinges are inserted using co-extrusion. Co-extrusion allows two or more different types of plastic to be extruded simultaneously through one die to produce a single homogenous extruded profile. Using this method, soft flexible hinges may be fitted between much harder plastics.

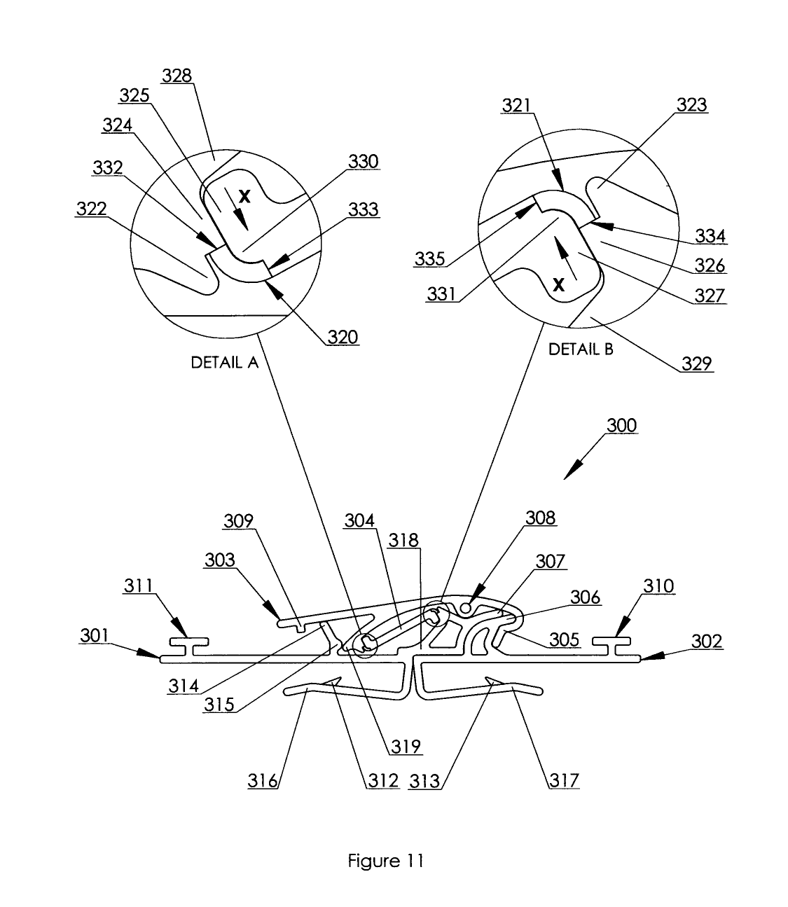

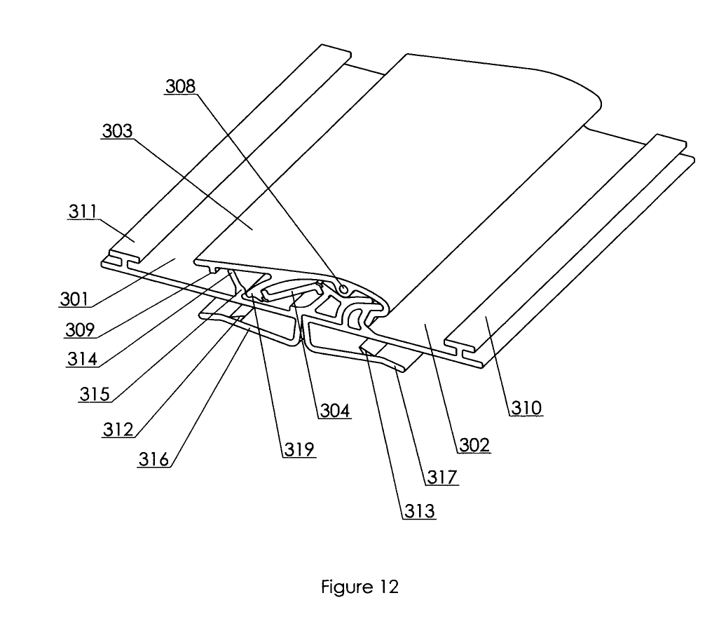

As shown in FIG. 11, the latch 300 embodies the present invention such that latch 300 comprises a first part 301 and a second part 302 arranged to be attached to respective opposing flaps of a box lid. While this form is now described with reference to applications in a box lid, it is applicable more generally.

Concerning the present application, each of the first and second parts are extruded. The first part 301 consists of a base part 318, an intermediate compression bar 304 and a latching arm 303.

The base part 318 is connected to the compression bar 304 via a flexible hinge 321. The opposite end of the compression bar 304 is connected to the latching arm 303 via a second flexible hinge 320.

Flexible hinge 320 is connected to the compression bar and the latching arm at faces 333 and 332 respectively. The long edges of the hinge (shown in FIG. 11 as being curved) are not directly attached to either the compression bar or the latching arm. When the latch is in the closed position the hinge 320 rests against curved surface 330 but is not physically attached other than at attachment faces 332 and 333.

The arrangement is generally similar for hinge 321, except that the attachment point to the compression bar is 335 and to the base at 334. The associated curved surface is 331.

As the latch is opened, both hinges unfurl from their curved state, allowing the hooked part 305 to be disengaged from the keeper point 306.

When closing the latch, hooked part 305 is located beneath the keeper point 306 and the latching arm is depressed towards the base 301. Maximum compression occurs when the tip of 305 and the two hinges are in alignment. As the latch is depressed further, the hinges pass the point of alignment and compression starts to decrease.

Pushing the latch as far as possible causes tip 319 to ride over bump 315, thus providing an additional mechanism for maintaining the latch in the closed position.

In the closed position the latching arm 303, rests on support 314. This provides additional mechanical strength in situations when boxes are stacked on top.

Whilst closing, the hinges increasingly wraps around the curved surfaces 330 and 331. This wrapping motion tends to maintain the hinges in tension. This tension ensures that faces 324/325 and 326/327 become aligned accurately during the closure phase. This alignment ensures that much of the compression is taken up by the hard plastic, rather than the soft hinges.

As the hinges are stretched around curved surfaces 330/331, and the hinges are anchored at locations 332/334, the compression bar is limited in its range of movement in the X direction (see FIG. 11).

Whilst closing, movement in the −X (negative X) direction is restricted by the sloping faces 328 and 329. The sloping angle is designed to move the compression bar in an X direction thus aligning faces 324/325 and 326/327 and forcing the hinges to wrap around curved surfaces 330 and 331.

Whilst closing the latch, the compression bar is at its maximum compression. Forces are perpendicular to X along the axis of the compression bar. This tends to distort the shape of the hinge in the direction of the force. To prevent excessive distortion bumps 322 and 323 have been included. These are placed to allow the hinges to press against them whilst the arm is under compression. The bumps have been kept to a minimum height to prevent breakage of the hinge in situations where the latch is accidentally folded all the way back such that the compression bar is 180 degrees away from its normal closed position.

In the closed position, keeper point 306 is sandwiched between latch components 305 and 307. The ‘U’ shape of the hook 305 holds 306 closely adjacent to 307 and acts to prevent the keeper part 302 from moving downwards away from the latch part 301.

The components 316 and 317 lie beneath the box lids and serve to secure the latch and keeper parts to the box lids. Flexible rubber barbs 312 and 313 are designed to provide extra friction between the latch/keeper and the box lids. They are angled to make it difficult to pull the latch or keeper off the box lids.

Hole 308 is provided to allow the attachment of fixing accessories at the ends of the latch (See FIG. 11). Fixing accessories can be used to secure the latch and keeper to both the lids and to the sides of the box. The fixing accessory may contain holes through which a cable tie could pass. This allows the latch and keeper to be secured to a fixing point attached to the side of the box. The accessory may be designed such that the fixing screw is not accessible when the cable tie is in place. This prevents the box from being unlocked by removing the screw.

T sections 310 and 311 allow additional fixing/locking accessories to be attached to the latch and/or keeper. The accessories can be slid on from the end and then held in place using a fixing screw or adhesive. The accessories can provide holes through which cable ties can be fitted. Holes can be punctured through the box lids to enable the cable ties to be passed through into the box and then back out again. This enables the use of cable ties to secure the latch and keeper to the box lids.

Fixing/locking accessories can also be fitted onto the latch arm itself by sliding along component 309. The accessory can be used in conjunction with a similar component on T section 311 to provide a locking/securing mechanism. The accessory can be secured to the latching arm using a fixing screw on the underside of the latching arm. This would only be accessible when the latch is open, thus making it difficult to unscrew when the latch is locked.

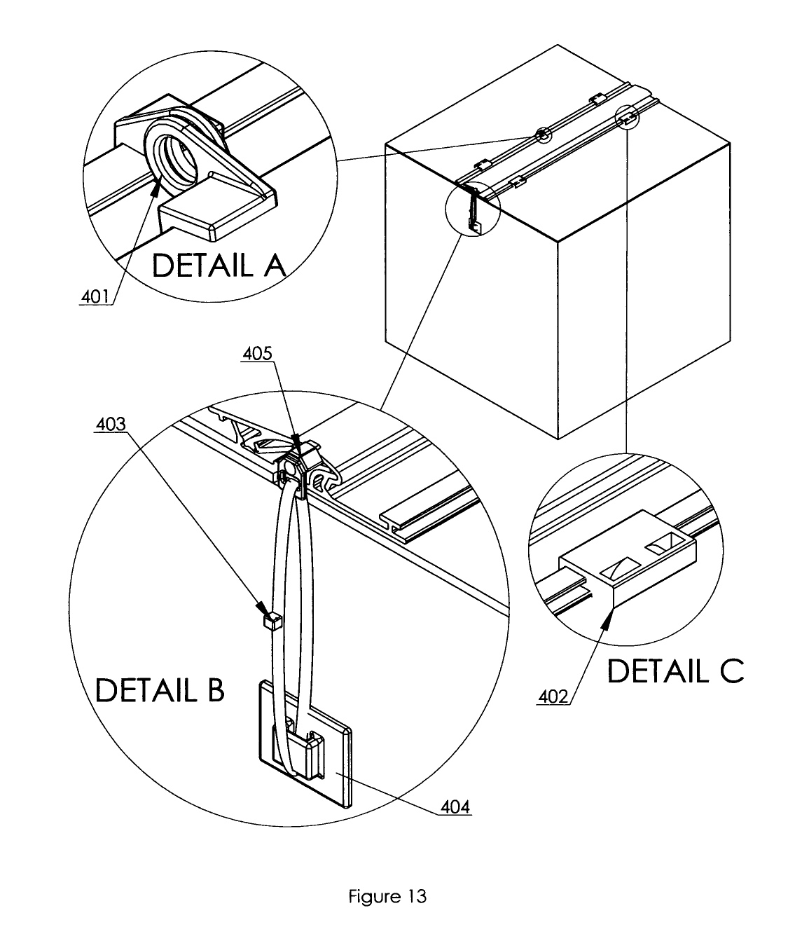

FIG. 13 shows an arrangement for securing a box with the latch of the present invention, and is applicable to any of the embodiments of the present invention.

Clasp 401 is slid on to rails 309 and 311 to provide a padlock locking facility. A fixing screw beneath the component prevents it from being slid off the rail.

Lock 402 is slid onto rails 310 and 311. Cable ties can be passed through the holes and then through corresponding puncture holes in the box lid. This enables the latch and keeper to be securely fastened to the lids.

Latch 405 is fastened to the end of the latch using a fixing screw that locates in the hole provided. A hinged lid folds down to cover the screw head. The lid contains a slot through which a cable tie can be passed, 403. The cable tie passes through an adhesive pad 404 thus securing the latch to the sides of the box.

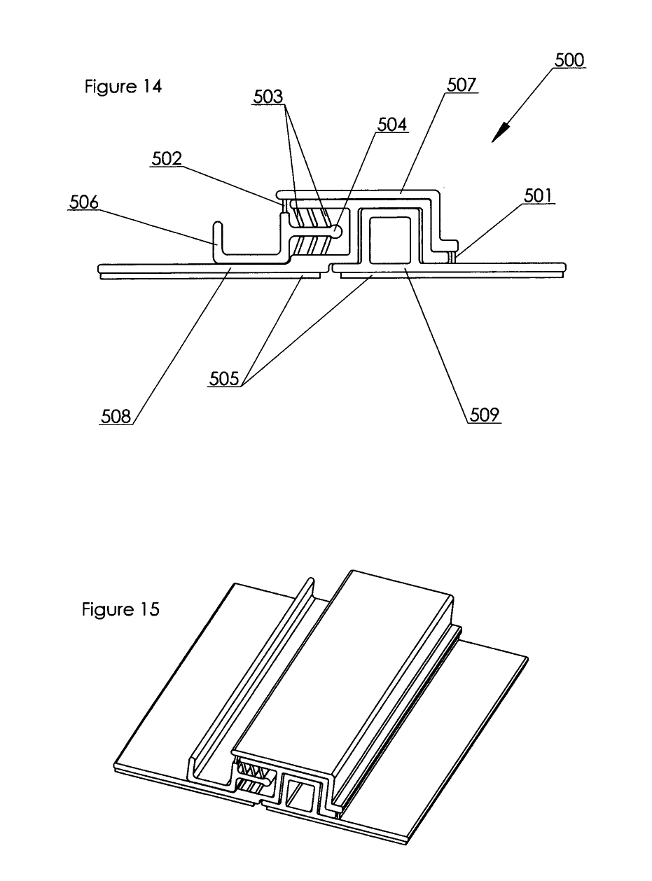

There is shown in FIGS. 14 and 15 a further embodiment, having flexible hinges, 501, 502, rubber fins 503 designed to hold an arm 504 in position. Adhesive strips 505 attach the latch and anchor to the box flaps.

To open the latch, lever 506 is pulled outward away from the fins 503. Hinge 502 rotates to allow item 504 to slide between the fins. When 504 is disengaged from the fins, latch 507 can be lifted an rotates about hinge 501.

The latch is now fully unlocked, and item 508 can be lifted up from item 509, i.e. the left box flap can be lifted upwards and away from the right.

The closing procedure is the reverse of the above procedure. The latch is held shut by squeezing item 504 into the fins.

Advantages of the latch of the present invention, and also features for its suitability for extrusion, include the following:
The design has a uniform cross section thus making it suitable for extrusion.
Co-extrusion allows for two different types of plastic to be bonded together to form a homogenous unit. The high strength of the bond and the availability of plastics with varying degrees of flexibility means that a strong flexible hinge can be incorporated between harder plastics. The latch makes use of this co-extrusion process to insert two hinges.
The latch arrangement ensures that most of the compression force is taken up by the compression bar rather than the hinges. This prevents the hinges from becoming excessively distorted during closure.
The arrangement of hinges ensure they do not get trapped between the adjacent harder plastics as the latch is being closed.
The latch and keeper provide uniform wall thickness that is readily suitable for the extrusion process.
The latch doesn't need lubrication or oils to prevent corrosion. The hinges do not jam due to component corrosion.
Metal latches with multiple individual components can be affected by the ingress of dirt into the hinge areas. The extruded latch does not suffer from this problem as the hinge is a homogenous part of the latch.
Conventional multiple component based latches have areas that are awkward to access making them difficult to fully clean or sterilise. Due to the homogenous nature of the extruded latch, cleaning and sterilising is simpler and more effective due to the lack of inaccessible pockets. The latch can be cleaned by wiping along the length of the latch in the direction of the extrusion.
Various anti-bacterial plastics and additives are available to reduce the build-up of bacteria on the latch. These can be added in the extrusion process.
The latch can be drilled at any position along it's length to allow insertion of bolts, screws or nails to attach the latch to a body. This provides flexibility in the positioning of the fixings and allows them to be positioned in the most appropriate location as opposed to having to position them where the latch dictates.
The latch is plastic and therefore offers good electrical insulation properties.
Also good heat insulating properties.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of to features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A latch for releasably securing two surfaces together, the latch comprising
a first part and a second part arranged to be attached to respective opposing surfaces, the first and second parts comprising respective first and second attachment elements arranged to releasably engage one another thereby to secure the surfaces together, wherein the attachment elements are elongate with a substantially uniform cross-section along their length,
wherein the first attachment element comprises a keeper and the second attachment element comprises a hooked part, wherein the hooked part is connected to a base of the second part by a hinge mechanism, the hinge mechanism being arranged to allow the hooked part to be positioned over the keeper and to be moved into a latched position in which the hooked part engages the keeper to secure the first and second parts together.

2. (canceled)

3. (canceled)

4. (canceled)

5. (canceled)

6. The latch of claim 1 wherein the hinge mechanism is arranged to maintain the engagement between the hooked part and the keeper in the latched position.

7. The latch of claim 1 wherein the hinge mechanism comprises an intermediate part connecting the hooked part to the base of the second part, the intermediate part comprising a first hinge element connecting the hooked part to the intermediate part and a second hinge element connecting the intermediate part to the base.

8. The latch of claim 7 wherein, in the latched position, the intermediate part is arranged to be under compression in such a way that, via its connection with the hooked part and the base, it urges the hooked part against the keeper in order to secure the hooked part in the latched position.

9. The latch of claim 8 wherein each hinge element comprises a region of material which is of reduced rigidity compared to surrounding regions.

10. The latch of claim 1 wherein each of the first and second attachment elements comprises at least one of a hook and loop connector and a magnetic part.

11. (canceled)

12. The latch of claim 1 wherein one or both of the first and second parts comprises a securing clip for attachment to an edge of the respective box lid flap.

13. (canceled)

14. The latch of claim 1 comprising a locking mechanism arranged to lock the first and second attachment elements together.

15. The latch of claim 14 wherein the locking mechanism comprises a locking pillar arranged to be inserted through an aperture in one or both of the first and second attachment elements.

16. The latch of claim 15 wherein an upper part of the locking pillar comprises an aperture through which a padlock or lock can be inserted.

17. The latch of claim 16 wherein the locking pillar is rotatably mounted within the aperture in at least one of the first attachment and second attachment element, the locking pillar comprising an upper part having a non-circular cross-section, the aperture in the first and/or second attachment element comprising a corresponding non-circular cross-section, the upper part being rotatable between a locked position in which its cross-section prevents its passage through the aperture and an unlocked position in which it may pass through the aperture.

18. (canceled)

19. (canceled)

20. The latch of claim 1 wherein each of the first and second parts consists of an extruded length of material.

21. (canceled)

22. A box including the latch of claim 1.

23. A method of manufacturing a latch for releasably securing two surfaces together, the method comprising
producing first and second parts of the latch, the first and second parts being arranged to be attached to respective opposing surfaces, the first and second parts comprising respective first and second attachment elements arranged to releasably engage one another thereby to secure the surfaces together, wherein the latch is elongate and the first and second parts have a substantially uniform cross-section along their length,
providing the first attachment element with a keeper and the second attachment element with a hooked part, wherein the hooked part is connected to a base of the second part by a hinge mechanism, the hinge mechanism being arranged to allow the hooked part to be positioned over the keeper and to be moved into a latched position in which the hooked part engages the keeper to secure the first and second parts together.

24. (canceled)

25. (canceled)

26. The method of claim 23 comprising producing the first and second parts using extrusion.

27. The method of claim 26 comprising producing the first and second parts using injection moulding.

28. The method of claim 23 comprising cutting one or both of the first and second parts to a desired length.

29. (canceled)

30. (canceled)

31. The latch of claim 7 wherein each hinge element comprises a region of material which is of reduced rigidity compared to surrounding regions.

32. The latch of claim 15 wherein the locking pillar is rotatably mounted within the aperture in at least one of the first attachment and second attachment element, the locking pillar comprising an upper part having a non-circular cross-section, the aperture in the first and/or second attachment element comprising a corresponding non-circular cross-section, the upper part being rotatable between a locked position in which its cross-section prevents its passage through the aperture and an unlocked position in which it may pass through the aperture.
